(19) United States
(12) Patent Application Publication
(10) Pub. No.: US 2026/0220334 A1
(43) Pub. Date: Jul. 30, 2026

(54) GENERATING CAD ACTION SEQUENCE BY MACHINE LEARNING

(71) Applicant: Autodesk, Inc., San Francisco, CA (US)

(72) Inventors: Joseph George Lambourne, London (GB); Ka Heng Shiu, London (GB); Pradeep Kumar Jayaraman, Ajax (CA); Peter Meltzer, London (GB)

(21) Appl. No.: 19/040,702

(22) Filed: Jan. 29, 2025

(51) Int. Cl. G06F 30/27; G06F 30/10

(52) U.S. Cl. CPC G06F 30/27; G06F 30/10

(57) ABSTRACT

Methods, systems, and apparatus, including medium-encoded computer program products, for generating CAD action sequence using machine learning, include: receiving a representation of a three-dimensional object to be modified; generating a state encoding for the object from the representation of the three-dimensional object; autoregressively predicting a sequence of a plurality of subsequent modification actions to be performed on the object including: repeatedly performing a masked attention process using a current sequence conditioned on the generated state encoding of the object, wherein the masked attention process uses: (i) a causal self-attention mask that allows the masked attention process to attend to encodings of prior actions, and (ii) a causal cross-attention mask that allows the masked attention process to attend to one or more state encodings of the object; and displaying a final sequence of predicted modification actions for the object in a user interface of a computer modeling program.

### BACKGROUND

This specification relates to computer aided design of physical structures.

Computer Aided Design (CAD) systems have been developed and used to generate three-dimensional (3D) representations of objects, and Computer Aided Manufacturing (CAM) systems have been developed and used to manufacture the physical structure of those objects, e.g., using Computer Numerical Control (CNC) manufacturing techniques. The CAD systems can include software tools that can be used to design, redesign, and enhance 3D parts of the objects. The CAD systems can be used in conjunction with additive or subtractive manufacturing systems and techniques.

Traditionally, users of CAD systems manually generate CAD models to achieve a design goal by exploring shapes with aesthetic and functional advantages. For example, a designer might optimize the physical properties of a part to maximize strength while minimizing weight and manufacturing cost. However, the construction of CAD models can be time consuming and may require the expertise of professional designers.

### SUMMARY

With the advancement of machine learning and artificial intelligence, some CAD systems can use a machine learning model to generate a sequence of CAD actions by predicting the steps needed to construct or modify a 3D model. Some CAD systems treat the CAD action sequence generation problem as a language modeling task, without considering the evolving 3D geometry of the 3D model. Some CAD systems generate next CAD actions solely based on a sequence of previous CAD actions.

However, the CAD systems that generate next CAD actions solely based on a sequence of previous CAD actions do not use spatial locality of the actions and global state of the 3D model to predict the next CAD actions. In addition, the CAD systems that generate next CAD actions solely based on a sequence of previous CAD actions are not computationally efficient. Some actions in the sequence of previous CAD actions can be commutative, and thus it may not be necessary to keep track of the order of actions that result in a state change of the 3D model.

For example, different ordering for the extrusion actions performed in a model can produce the same 3D shape and can be interchangeable. Further, the “Extrude” action results in a state change of the 3D model, e.g., from a 2D triangle to a 3D triangular prism. Storing and processing the sequence of previous CAD actions can take lots of computation resources.

This specification describes technologies relating to computer aided design of physical structures by generating CAD models using machine learning. In particular, the specification relates to automatically generating CAD action sequences based on states of the geometry of the CAD models.

In general, one or more aspects of the subject matter described in this specification can be embodied in one or more methods (and also one or more non-transitory computer-readable mediums tangibly encoding a computer program operable to cause data processing apparatus to perform operations) including: receiving a representation of a three-dimensional object to be modified; generating a state encoding for the object from the representation of the three-dimensional object; autoregressively predicting a sequence of a plurality of subsequent modification actions to be performed on the object including: repeatedly performing a masked attention process using a current sequence conditioned on the generated state encoding of the object, wherein the masked attention process uses: (i) a causal self-attention mask that allows the masked attention process to attend to encodings of prior actions, and (ii) a causal cross-attention mask that allows the masked attention process to attend to one or more state encodings of the object; and displaying a final sequence of predicted modification actions for the object in a user interface of a computer modeling program.

The causal self-attention mask can be a sparsified causal self-attention mask that masks out encodings of prior actions that resulted in a state change of the object. The prior actions that resulted in a state change of the object can include prior actions that modified a geometry of the object. The sparsified causal self-attention mask can prevent the masked attention process from attending to the encodings of the prior actions that resulted in a modified geometry of the object. The causal cross-attention mask can be a sparsified causal cross-attention mask that allows the masked attention process to attend to a state encoding of a current state for the object and prevents the masked attention process from attending to one or more previous state encodings of one or more previous states for the object that are before the current state for the object. The final sequence of predicted modification actions for the object can include actions that do not have a corresponding state encoding.

The method (or operations performed by the data processing apparatus in accordance with the computer program tangibly encoded in one or more non-transitory computer-readable mediums) can include: training a transformer model to perform the masked attention process. Training the transformer model can include: obtaining a collection of sequences of modification actions; generating a respective training example from each sequence of modification actions, including: generating, for the sequence of modification actions, one or more state encodings for an object generated at one or more locations in the sequence, and generating the training example as the one or more state encodings and one or more subsequent modification actions in the sequence; and training the transformer model using the generated training examples. Training the transformer model using the generated training examples can include using a different respective causal self-attention mask and a different respective causal cross-attention mask for each training example. For each training example, the causal cross-attention mask can allow the masked attention process to attend to one or more state encodings that are before and up to a current state for the object and can mask out one or more state encodings that are after the current state for the object. For each training example, the causal cross-attention mask can be a sparsified causal cross-attention mask, and the sparsified causal cross-attention mask can allow the masked attention process to attend to the state encoding of a current state for the object and can mask out one or more state encodings that are both before and after the current state for the object.

One or more aspects of the subject matter described in this specification can also be embodied in one or more systems including: a non-transitory storage medium having instructions of a computer modeling program stored thereon; and one or more data processing apparatus configured to run the instructions of the computer modeling program to perform operations specified by the instructions of the computer modeling program; wherein the operations include: receiving a representation of a three-dimensional object to be modified; generating a state encoding for the object from the representation of the three-dimensional object; autoregressively predicting a sequence of a plurality of subsequent modification actions to be performed on the object including: repeatedly performing a masked attention process using a current sequence conditioned on the generated state encoding of the object, wherein the masked attention process uses: (i) a causal self-attention mask that allows the masked attention process to attend to encodings of prior actions, and (ii) a causal cross-attention mask that allows the masked attention process to attend to one or more state encodings of the object; and displaying a final sequence of predicted modification actions for the object in a user interface of a computer modeling program.

Particular embodiments of the subject matter described in this specification can be implemented to realize one or more of the following advantages.

Rather than relying solely on past action sequences, the CAD systems can autoregressively generate CAD action sequences using a trained machine learning model that incorporates the evolving state of the CAD model into the decision-making process. Because adding the state information can enhance the performance of the action sequence modeling and prediction, the CAD systems can predict actions more efficiently and more effectively based on the global 3D state of the CAD model, leading to faster training of the machine learning model and reducing the computation complexity.

In some implementations, the systems and techniques can generate a CAD action sequence without requiring the knowledge of a past CAD action sequence, instead relying only on the current state of the geometry of the CAD model. By predicting a sequence of CAD actions with a reduced context length, the systems and techniques can reduce the memory, such as graphics processing unit (GPU) memory, and computational complexity required to perform action sequence predictions. Therefore, the CAD action sequence generation techniques are more feasible to be used on consumer devices, which may have less computation resources, such as memory and processing power.

Complete CAD action sequences which define a CAD model can be difficult to obtain from available data sources. Thus, there may not be enough data to train a machine learning model that generates CAD action sequences solely based on past action sequences, and once trained, the machine learning model may not be applicable to situations where complete past action sequences are unavailable. On the contrary, CAD action sequences which represent the last few actions in a CAD model design can be more commonly available. For example, the CAD action sequences which represent the last few actions can be extracted using feature recognition, or from “Undo” data stored in the files used by a CAD modeling program. Therefore, the CAD action sequence generation techniques based on a current state of the CAD model can be applicable to situations where complete past action sequences are unavailable.

Some CAD systems that use sequence generation models can encode CAD actions in a domain specific language. For example, sketch curve creation, extrusions, revolutions, and fillet creation actions can be encoded in a domain specific language. However, a CAD system can have many other advanced functions which cannot be encoded in the same domain specific language. For example, a swept bodies action cannot be encoded in the same domain specific language as some other actions. Supporting the additional actions by extending a domain specific language can require a lot of computational resources. The CAD action sequence generation systems and techniques discussed herein can autocomplete a CAD model to add features onto complex bodies using a domain specific language for actions corresponding to the features, without a need to extend the domain specific language to cover many other advanced functions in a CAD system, thus reducing the computational resources.

The details of one or more embodiments of the subject matter described in this specification are set forth in the accompanying drawings and the description below. Other features, aspects, and advantages of the invention will become apparent from the description, the drawings, and the claims.

### BRIEF DESCRIPTION OF THE DRAWINGS

FIG. 1 shows an example of a system usable to design and manufacture physical structures.

FIG. 2 shows an example of a masked attention process to predict actions.

FIG. 3A shows an example of a sequence of actions and a sequence of states of a 3D model.

FIG. 3B shows an example of a causal self-attention mask.

FIG. 3C shows an example of a causal cross-attention mask.

FIG. 3D shows an example of a sparsified causal self-attention mask.

FIG. 3E shows an example of a sparsified causal cross-attention mask.

FIG. 3F shows an example of action positional encoding.

FIG. 3G shows an example of sparsified action positional encoding.

FIG. 4 is a flowchart showing an example of a process to generate a 3D action sequence using a machine learning algorithm.

FIG. 5 is a flowchart showing an example of a process to train a machine learning model that can be used to generate a 3D action sequence.

FIG. 6 is a schematic diagram of a data processing system usable to implement the described systems and techniques.

Like reference numbers and designations in the various drawings indicate like elements.

### DETAILED DESCRIPTION

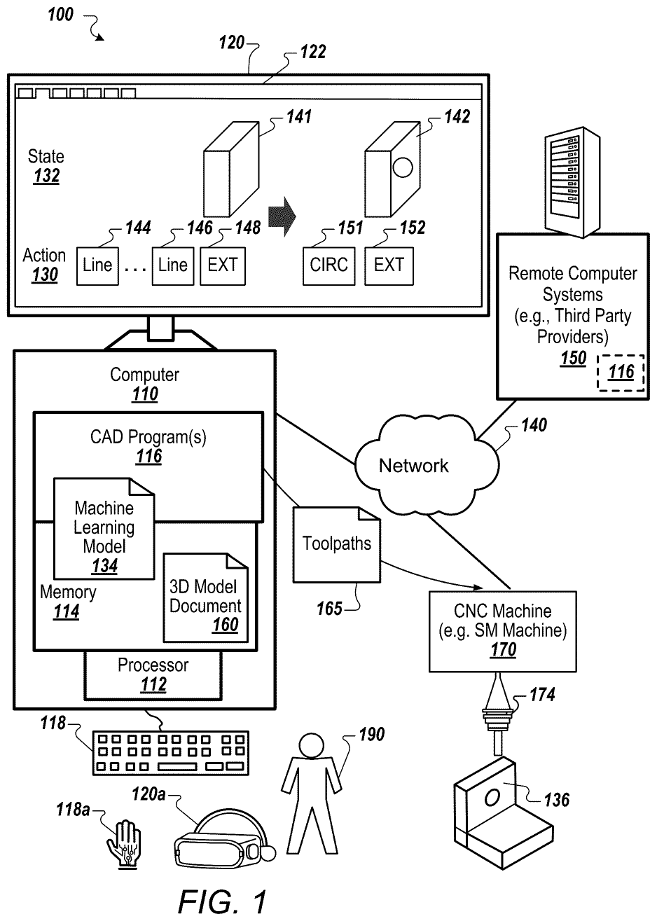

FIG. 1 shows an example of a system 100 usable to design and manufacture physical structures. A computer 110 includes a processor 112 and a memory 114, and the computer 110 can be connected to a network 140, which can be a private network, a public network, a virtual private network, etc. The processor 112 can be one or more hardware processors, which can each include multiple processor cores. The memory 114 can include both volatile and non-volatile memory, such as Random Access Memory (RAM) and Flash RAM. The computer 110 can include various types of computer storage media and devices, which can include the memory 114, to store instructions of programs that run on the processor 112.

Such programs include one or more 3D modeling, simulation and/or manufacturing control programs, such as Computer Aided Design (CAD) program(s) 116. The program(s) 116 can run locally on computer 110, remotely on a computer of one or more remote computer systems 150 (e.g., one or more third party providers' one or more server systems accessible by the computer 110 via the network 140) or both locally and remotely. A machine learning model 134 can be stored in the memory 114 (and/or in the one or more remote computer systems 150) and can be accessed by the CAD program(s) 116.

The CAD program(s) 116 can create and/or modify a 3D model of a target 3D object 136. The creation and/or modification of a 3D model can involve a sequence of actions 130. Examples of the actions include actions that add or modify a shape in two-dimensional (2D), such as the “Add line” action 144 that adds a line, and the “Add circle” action 151 that adds a circle. Examples of the actions also include actions that extend 2D shapes into three-dimensional (3D) or modify a model in 3D, such as the “Extrude” action 152, revolving an edge in 3D, and blending an edge in 3D to create an edge blend (fillet). Other examples of actions that can modify the 3D geometry of a 3D object include creating a body of revolution from a profile which is spun around an axis and adding or subtracting the body from a main body of a CAD model, and creating a shell of a solid model, e.g., by emitting a point indicating the pierce face and then defining the thickness of the shell.

The creation and/or modification of a 3D model can involve a sequence of states 132. Not every action in a sequence of actions can result in a change of a state of an object. Some actions can result in a change of the state of the object. In some implementations, actions that extend 2D shapes into 3D or modify shapes in 3D can result in a state change that modifies a geometry of the object. For example, the “Extrude” action 152 can extend a rectangle created by the “Add line” actions 144 to 146 to a 3D hexahedron shape, resulting in the state 141. Some actions do not result in a state change of the object. 2D actions that add or modify a shape in 2D do not result in a state change that modifies a geometry of the object. For example, the “Add line” action 144 and “Add circle” action 151 are 2D actions that do not result in a state change.

The CAD program(s) 116 can automatically generate CAD action sequences based on one or more states of the geometry of the CAD models. The CAD program(s) 116 can obtain a state 141 of a 3D model of a target 3D object 136. The state 141 can be a result of an initial design of the target 3D object 136. The state 141 can be defined in the computer using various known 3D modeling formats, such as using solid models (e.g., voxels) or surface models (e.g., boundary representation (B-Rep), surface meshes). In some implementations, the program(s) 116 can obtain one or more previous states before the state of the 3D model of the target 3D object. The program(s) 116 can obtain state data representing the state and the one or more previous states.

A sequence of prior actions can result in the state 141 of the 3D model. For example, a sequence of prior actions “Add line” 144, . . . , “Add line” 146, and “Extrude” 148 can result in the state 141 of the 3D model of the target 3D object 136. The program(s) 116 can obtain action data representing the sequence of prior actions.

The CAD program(s) 116 can use a machine learning model 134 to generate a sequence of subsequent modification actions to be performed on the state 141 of the target object 136. The machine learning model 134 can autoregressively predict the sequence of subsequent modification actions based on the state 141, and optionally, one or more previous states and/or the sequence of prior actions. For example, the machine learning model 134 can predict the sequence of subsequent modification actions, including “Add circle” 151 and “Extrude” 152, based on both the state 141 and the sequence of prior actions 144, . . . , 146, and 148. As another example, the machine learning model 134 can predict the sequence of subsequent modification actions 151 and 152 only based on the state 141, without using the sequence of prior actions 144, . . . , 146, and 148.

In some implementations, the machine learning model 134 can be configured to process an input sequence of tokens to generate an output sequence of tokens. The tokens can represent any appropriate type of content, e.g., text, image, video, audio, or some combination of the above. An action token is an atomic piece of information that describes at least a part of a CAD action using a domain specific language. An action can be defined using one or more action tokens. For example, one or more action tokens can represent a CAD action that is used for constructing or modifying a CAD model of an object. One or more state tokens can represent a state of a CAD model of an object.

For example, a human designer can model some geometry using the CAD program(s) 116. The system 100 can record the modeling actions in a 3D model document 160. The system can convert the modeling actions into a domain specific language. Thus, each modeling action is represented by one or more action tokens in the domain specific language. The CAD program(s) 116 can execute CAD commands for the modeling actions in groups. Each command group can be sufficient to define a change to the 3D model geometry. For example, each command group can include commands to define a modeling feature, such as addition or subtraction of an extrusion action, or a revolution action. Executing a command group can result in a B-rep model. The system 100 can encode the B-rep model to create one or more state tokens representing the state of the CAD model. The machine learning model 134 can be a transformer model (e.g., a decoder of a transformer model) and can be configured to process an input sequence of action tokens and an input sequence of state tokens to generate an output sequence of predicted action tokens.

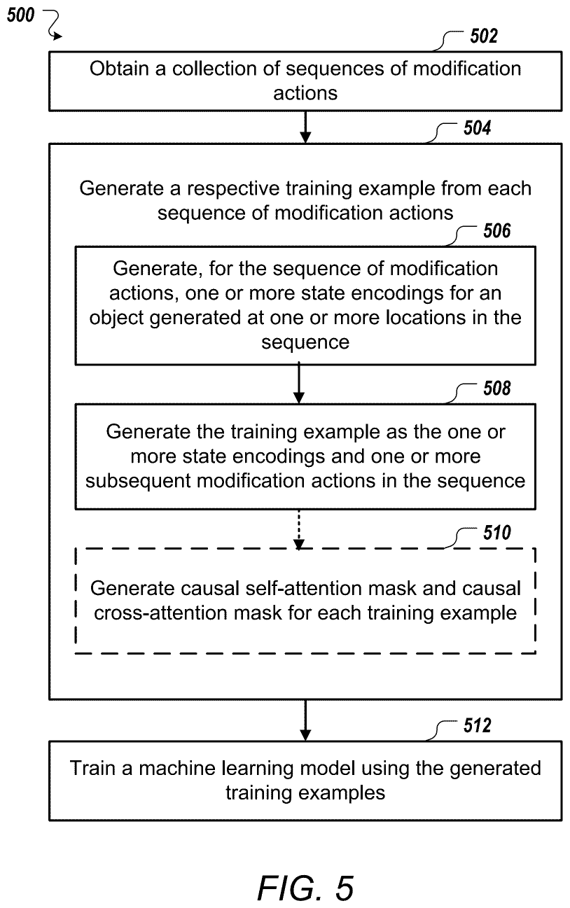

The machine learning model 134 can be any appropriate neural network that receives an input sequence of actions and auto-regressively generates an output sequence of actions. For example, the generative model can be a transformer neural network. The machine learning model 134 has been trained to autoregressively predict a sequence of subsequent actions from encodings of the prior actions (e.g., prior actions 144, . . . , 146, and 148) and an encoding of a state (e.g., the state 141). Details of training the machine learning model are described herein in connection with FIG. 5.

An encoding, as used in this specification, is a numeric representation of features of an input token, such as an action token or a state token. In particular, an encoding is a numeric representation in an embedding space, i.e., an ordered collection of a fixed number of numeric values, where the number of numeric values is equal to the dimensionality of the embedding space. The embedding space can be a high dimensional space and encodings can be points in the high dimensional space. For example, the encoding can be a vector of floating point or other types of numeric values. Generally, the dimensionality of the embedding space is much smaller than the number of numeric values in the input data represented by a given encoding.

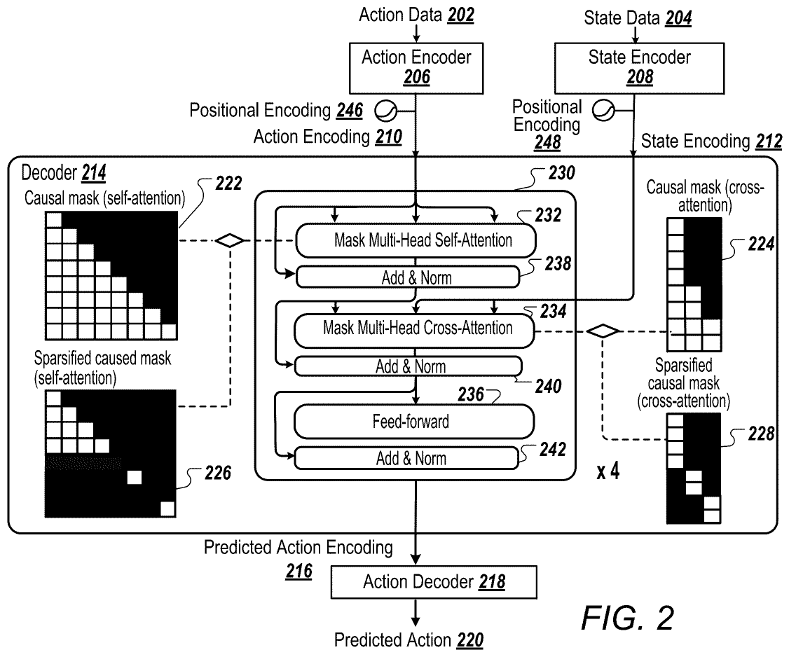

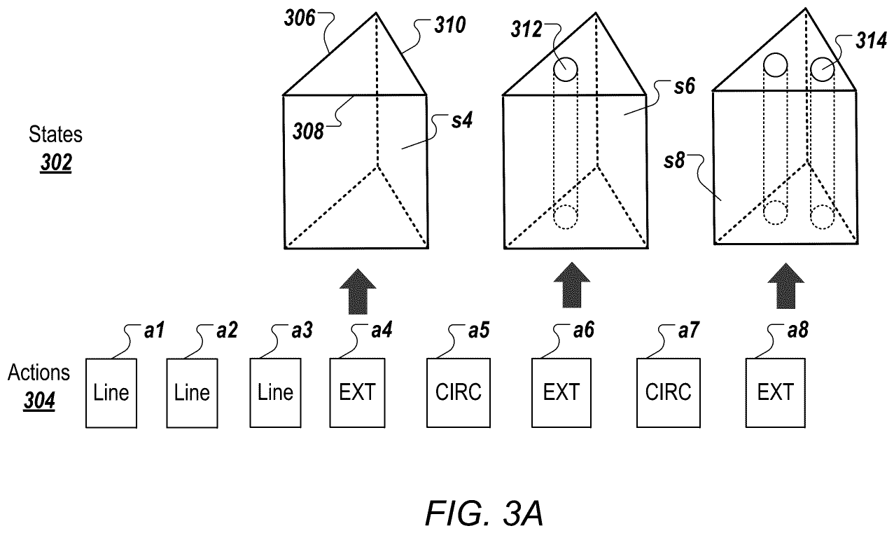

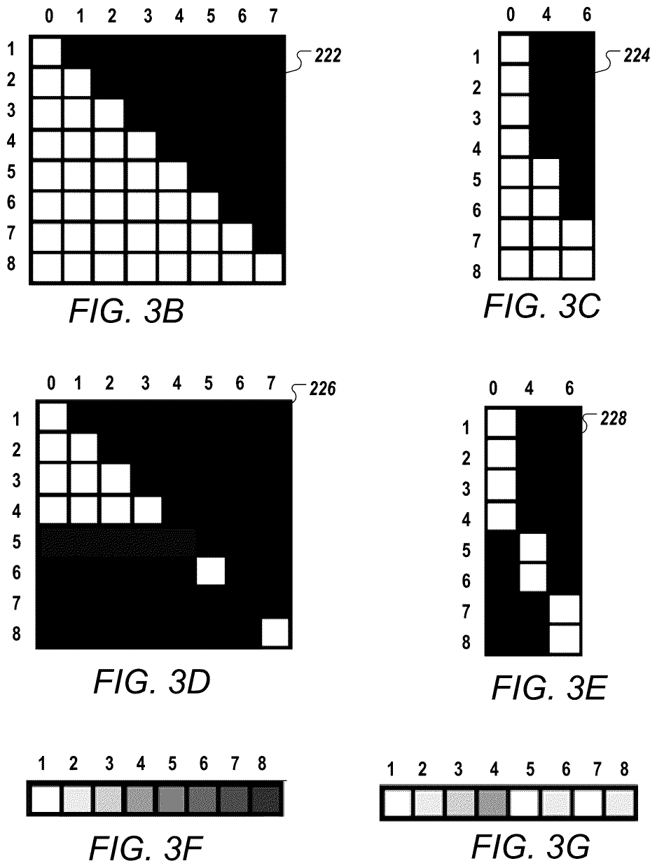

The CAD program(s) 116 can use the machine learning model in an autoregressive manner. The CAD program(s) 116 can predict the next action in the sequence based on at least the state of the object. The CAD program(s) 116 can repeatedly perform a masked attention process to generate a subsequent action sequence based on a state encoding of the object. Therefore, by using state encodings, the automatic CAD action sequence generation can accelerate the 3D model generation process. The automatic CAD action sequence generation can reduce the time needed to produce a manufacturable structure and likewise reduce the time needed to go from conception of new parts to the actual manufacture of those new parts. Details of the masked attention process are described below in connection with FIG. 2 and FIGS. 3A-3G.

The CAD program(s) 116 presents a user interface (UI) 122 on a display device 120 of the computer 110, which can be operated using one or more input devices 118 of the computer 110 (e.g., keyboard and mouse). While shown as separate devices in FIG. 1, the display device 120 and/or input devices 118 can also be integrated with each other and/or with the computer 110, such as in a tablet computer or in virtual reality (VR) or augmented reality (AR) system. For example, the input/output devices 118, 120 can include a VR input glove 118a and a VR headset 120a.

The program(s) 116 can include in the UI 122 a series of menus that allows the user 190 to accept or reject one or more actions 130 in the sequence of predicted modification actions automatically generated by the machine learning model 134. In some implementations, the program(s) 116 can include in the UI 122 a series of menus that allows the user 190 to adjust one or more actions in the sequence of predicted modification actions until a user is satisfied with the 3D model, e.g., a final state 142, that is constructed by the sequence of modification actions. Once the user 190 accepts the 3D model generated by the sequence of actions, the program(s) 116 can save the 3D model in a 3D model document 160. In addition, the user 190 can interact with the program(s) 116 to make additional modifications to the 3D model before it is saved in the 3D model document 160. For example, filets (e.g., rounded edges or corners) can be fitted based on the 3D model.

The 3D model generated by the CAD program(s) 116 can be used by a computer-controlled manufacturing system, e.g., by a CNC machine 170, such as a subtractive manufacturing (SM) machine, etc., to manufacture the target 3D object 136. This can be done using known graphical user interface tools. The 3D model can be defined in the computer using various known 3D modeling formats, such as using solid models (e.g., voxels) or surface models (e.g., B-Rep, surface meshes).

Once the 3D model of the target 3D object 136 is ready for manufacturing, the 3D model can be prepared for manufacturing the physical structure of the object 136 by generating toolpaths for use by the computer-controlled manufacturing system to manufacture the target 3D object 136. For example, the 3D model can be used to generate a toolpath specification document 165, which can be sent to the CNC machine 170 and used to control operation of one or more milling tools. This can be done upon request by the user 190, or in light of the user's request for another action, such as sending the 3D model document 160 to the CNC machine 170, or other manufacturing machinery, which can be directly connected to the computer 110, or connected via a network 140, as shown. This can involve a post-processing step carried out on the local computer 110 or a cloud service to export the 3D model document 160 to an electronic document from which to manufacture. Note that an electronic document (which for brevity will simply be referred to as a document) can be a file, but does not necessarily correspond to a file. A document can be stored in a portion of a file that holds other documents, in a single file dedicated to the document in question, or in multiple coordinated files.

The program(s) 116 can create one or more toolpaths in the document 165 and provide the document 165 (of an appropriate format) to the CNC machine 170 to create the physical structure of the target 3D object 136. In some implementations, the computer 110 can be integrated into the CNC machine 170, and so the toolpath specification document 165 can be created by the same computer that will use the toolpath specification document 165 to manufacture the object 136. For example, the CNC machine 170 can be a subtractive manufacturing machine that can manufacture the object by removing stock material. The CNC machine 170 can use the toolpaths (e.g., saved in the document 165) to control the cutting tool 174.

While the example above focuses on subtractive manufacturing, various other manufacturing systems and processes can be used, including additive manufacturing (AM) as well as hybrid AM+SM manufacturing. Moreover, the systems and techniques described in this application can also be used with the CAD program(s) 116 that support building construction management, game design, video and movie production. For example, 3D CAD design, as described in this application, can be used to generate a 3D character or a 3D object in a video/movie production workflow. Other applications are also possible.

FIG. 2 shows an example of a masked attention process 200 to predict actions. In some implementations, the system 100 can perform the masked attention process 200 during the inference of the machine learning model 134. In some implementations, the system 100 can perform the masked attention process 200 during the training of the machine learning model 134.

The system 100 receives a representation of a 3D object to be modified. For example, the system 100 receives state data 204 of a 3D object to be modified. The state data 204 are geometric representations of one or more states of the 3D object. The state data 204 can be in various known 3D modeling formats, such as using solid models (e.g., voxels) or surface models (e.g., B-Rep, surface meshes). The state data 204 can include one or more states of the 3D object during the construction or the modification of the 3D model of the 3D object. In some implementations, the state data 204 can include only the state of the 3D object and do not include any previous state before the state.

In some implementations, in addition to the state data 204, the system 100 can receive action data 202 of a 3D object. The action data 202 can include a sequence of prior actions that the system 100 has performed during the construction or the modification of a model of the 3D object. Some of the actions can result in a state described in the state data 204. Some of the actions can result in a previous state before the state described in the state data 204. Some of the actions are performed after the state and have not yet resulted in a state change.

For each action in the sequence of prior actions, the action data 202 can include data for an action type and data for one or more action arguments. The action type can be represented using a value having a predetermined length. Examples of action types include “SOL”, “Add line”, “Add arc”, “Add circle”, “Extrude”, and “EOS.” Each action type can have a corresponding value with a predetermined range, such as a range from 0 to 8.

Each action can have zero, one, two, or several arguments that define the parameters for the action. For example, the “Add line” action can have coordinate parameters x, y that define an endpoint of the line. The “Extrude” action can have parameters that define sketch plane orientation, sketch plane origin, scale of associated sketch profile, extrude distances towards both sides, Boolean type, and extrude type. The “SOL” (i.e., start of loop) and “EOS” (i.e., end of sequence) actions do not have parameters. The action data 202 can include data for the action arguments represented using one or more values having a predetermined length. For example, the data for the action arguments can use unsigned quantized 8-bit integers, with extra-1 value denoting it is padded. The data for the action arguments can have one or more values, such as {-1, 0, 1, . . . , 255}.

FIG. 3A shows an example of a sequence of actions 304 and a sequence of states 302 of a 3D model. The sequence of actions 304 includes “Add line” a1, “Add line” a2, “Add line” a3, “Extrude” a4, “Add circle” a5, “Extrude” a6, “Add circle” a7, and “Extrude” a8. The sequence of states 302 includes states s4, s6, and s8 of the 3D object. In particular, each of the “Extrude” actions a4, a6, and a8 results in a state change of the 3D object and modifies the geometry of the 3D object. In some implementations, the system 100 can interpret CAD actions 304 and based on the interpretation of the actions, the system can generate a geometric representation of the object, e.g., the states 302. For example, the CAD program(s) 116 can interpret CAD actions and generate geometric representations.

For example, the “Add line” actions a1, a2, and a3 draw three lines 306, 308, and 310 of a triangle, but do not result in a state change. The “Extrude” action a4 extends the triangle to a 3D triangular prism and results in the state s4. The “Add circle” action a5 adds a circle 312, but does not result in a state change. The “Extrude” action a6 extrudes the circle 312 in 3D through the triangular prism and results in the state s6. The “Add circle” action a7 adds another circle 314, but does not result in a state change. The “Extrude” action a8 extrudes the circle 314 in 3D through the triangular prism and results in the state s8.

Referring back to FIG. 2, the system 100 generates a state encoding for the object from the representation of the three-dimensional object. For example, the system 100 can generate a respective state encoding 212 by processing each state in the state data 204 using a state encoder 208. The state encoding 212 can be a vector representation of the state data 204. The state encoder 208 can include a neural network model that has been trained to encode each state included in the state data 204 into a state encoding 212 of the state. For example, the state encoder 208 can include a UV-Net neural network architecture designed to generate state encodings 212 directly from state data 204 in B-Rep data format. In some implementations, the state encoder 208 can be a point cloud encoder that encodes a point cloud representation of the state of the object, an image encoder that encodes an image of the state of the object, a text encoder that encodes a text description of the features of the state of the object, or a voxel encoder that encodes a voxel representation of the state of the object.

In some implementations, the system 100 can generate an action encoding 210 for the object from the action data 202. The system 100 can process the action data 202 for each action in a sequence of prior actions using an action encoder 206 to generate a respective action encoding for each action. The action encoding 210 is a vector representation of the action data 202. The action encoder 206 can include a neural network model that has been trained to encode features of the action data 202 into vector representations that are included in the action encoding 210. For example, the action encoder 206 can include one or more embedding layers of an autoencoder neural network model that was previously trained to generate the action encoding 210.

In some implementations, the action encoding 210 can be a vector generated by concatenating a vector representation of an action type of an action and a vector representation of action arguments of the action. In some implementations, the action encoder 206 can include a first embedding layer that processes action types of the actions in the action data 202 and generates encodings of the action types. The action encoder 206 can include a second embedding layer that processes action arguments of the actions in the action data 202 and generates encodings of the action arguments. The action encoder 206 can include a feed-forward layer to process a combination (e.g., a concatenation) of the encodings of the action types and the encodings of the action arguments to generate the action encoding 210.

The system 100 autoregressively predicts a sequence of a plurality of subsequent modification actions 220 to be performed on the object. The system 100 can include a machine learning model 134 that has been trained to process the action encoding 210 and the state encoding 212 to generate a sequence of predicted actions 220. In some implementations, the action encoder 206 and the state encoder 208 are included in the machine learning model 134 that has been trained to process the action data 202 and the state data 204.

The system 100 can generate predicted modification actions 220 based on both the sequence of prior actions 202 characterized in the action encoding 210 and the evolving state of the CAD model characterized in the state encoding 212. In some implementations, the machine learning model 134 can include: (i) a decoder 214 that generates a predicted action encoding 216 from action encoding 210 and state encoding 212, and (ii) an action decoder 218 that decodes the predicted action encoding 216 to generate the predicted action 220.

In some implementations, the system 100 can use a decoder 214 with a transformer architecture to autoregressively generate encodings 216 of the sequence of subsequent modification actions 220. The transformer architecture can have a self-attention mechanism and a cross-attention mechanism that allow the system 100 to process encodings of the sequence of actions in the action data 202 and to process encodings of the sequence of states in the state data 204 to generate an encoding 216 of a subsequent action.

The masked attention process 200 uses attention masks. The attention masks can tell the decoder 214 what action tokens or state tokens can be attended to while generating specific action tokens. In some implementations, the masked attention process 200 can use: (i) a causal self-attention mask 222 that allows the masked attention process to attend to encodings of prior actions, and (ii) a causal cross-attention mask 224 that allows the masked attention process to attend to one or more state encodings of the object. In some implementations, the system 100 can predict the next CAD action 220 based on both the previous actions in the actions data 202 and one or more states of the object in the state data 204.

The decoder 214 can include a predetermined number of identical layers 230. For example, the decoder 214 can include four, six, or eight identical layers 230. Each layer 230 can include three sub-layers: a masked multi-head self-attention layer 232, a masked multi-head cross-attention layer 234, and a feed-forward layer 236 (e.g., a fully-connection layer). The masked multi-head self-attention layer 232 processes the actions encoding 210 and generates an intermediate action encoding. The masked multi-head cross-attention layer 234 processes the intermediate action encoding and the state encoding 212, and generates an intermediate encoding. The feed-forward layer 236 processes the intermediate encoding and generates an encoding 216 of the predicted action.

In some implementations, each layer 230 can include a residual connection around each of the three sub-layers 232, 234, and 236, followed by layer normalization. For example, each layer 230 can include an “Addition and Normalization” layer, such as the layers 238, 240, and 242.

The sub-layer 232 is a multi-head self-attention layer that uses a masked self-attention mechanism. The multi-head self-attention mechanism allows the decoder 214 to jointly attend to information from the sequence of actions in the action data 202. The multi-head self-attention layer 232 can use a causal self-attention mask 222. The causal self-attention mask 222 allows the masked attention process to attend to action encodings 210 of actions that are before the predicted action and masks out one or more action encodings 210 of actions that are after the predicted action. The causal self-attention mask 222 can prevent the decoder 214 from attending to future actions in the sequence, ensuring that predictions for each action are based only on the previous actions the decoder 214 has already seen.

FIG. 3B shows an example of a causal self-attention mask 222 for the sequence of actions 304 in FIG. 3A. The columns represent the input actions: a0, a1, a2, a3, . . . , and a7. The action a0 can be “SOS” (i.e., start of sequence) or “BOS” (i.e., beginning of sequence), signaling the beginning of an action sequence. The rows represent the output actions: a1, a2, . . . ,a8. The causal self-attention mask 222 allows the masked attention process to attend to actions that are before a predicted action and masks actions that are at or after the predicted action. A black square indicates that a corresponding output action does not pay attention to a corresponding input action for the black square. A white square indicates that a corresponding output action pays attention to a corresponding input action for the white square. For example, when predicting the action a1, the causal self-attention mask 222 allows the masked attention process to attend to a0 (e.g., setting the element of the mask to 1) that is before a1 and masks out (e.g., setting the element of the mask to 0) a1 to a7 that are at or after the action a1. Similarly, when predicting the action a2, the causal self-attention mask 222 allows the masked attention process to attend to a0 and a1 that is before the action a2 and masks out a2 to a7 that are at or after the action a2.

Referring back to FIG. 2, the sub-layer 234 is a multi-head cross-attention layer that uses a masked cross-attention mechanism. The multi-head cross-attention mechanism allows the decoder 214 to attend to information from the sequence of states in the state data 204. The multi-head cross-attention layer 234 can use a causal cross-attention mask 224. The causal cross-attention mask 224 allows the masked attention process to attend to state encodings 212 of states that are before the predicted action and masks out one or more state encodings 212 of states that are after the predicted action. The causal cross-attention mask 224 can prevent the decoder 214 from attending to future states in the sequence of states, ensuring that predictions for each action are based only on the previous states the decoder 214 has already seen.

FIG. 3C shows an example of a causal cross-attention mask 224 for the sequence of actions 304 and the sequence of states 302 in FIG. 3A. The columns represent the input states (e.g., state tokens that are being attended to): s0, s4, and s6. The state s0 is a null state indicating that the model does not have a valid 3D geometric representation yet. The rows represent the output actions (e.g., action tokens being generated): a1, a2, . . . , a8. The causal cross-attention mask 224 allows the masked attention process to attend to states that are before a predicted action and masks states that are after the predicted action. For example, when predicting the action a5, the causal cross-attention mask 224 allows the masked attention process to attend to s0 and s4 (e.g., setting the element of the mask to 1) that is before the action a5 and masks out (e.g., setting the element of the mask to 0) s6 that is after the action a5. When generating the action a4, the causal cross-attention mask 224 masked out s4 such that action a4 cannot attend to state s4.

Referring back to FIG. 2, in some implementations, the system 100 can use sparsified causal masks, and the system can predict the next CAD action 220 based only on the last state of the object and the actions since the last state, further reducing computational cost without impacting the performance of the system. In some implementations, the masked attention process can use a sparsified causal self-attention mask 226, a sparsified causal cross-attention mask 228, or both. The sparsified causal self-attention mask 226 allows the masked attention process to attend to encodings of prior actions and masks out encodings of prior actions that resulted in a state change of the object. The sparsified causal cross-attention mask 228 allows the masked attention process to attend a state encoding of a state for the object and prevents the masked attention process from attending to one or more previous state encodings of one or more previous states for the object that are before the state for the object.

In some implementations, the system 100 can perform the masked attention process 200 using the sparsified causal self-attention mask 226 and the sparsified causal cross-attention mask 228. In some implementations, the system 100 can perform the masked attention process 200 using the causal self-attention mask 222 and the sparsified causal cross-attention mask 228. In some implementations, the system 100 can perform the masked attention process 200 using the sparsified causal self-attention mask 226 and the causal cross-attention mask 224.

FIG. 3D shows an example of a sparsified causal self-attention mask 226 for the sequence of actions 304 in FIG. 3A. The columns represent the input actions: a0, a1, a2, a3, . . . , and a7. The action a0 is a null action signaling the beginning of an action sequence. The rows represent the output actions: a1, a2, . . . , a8. The sparsified causal self-attention mask 226 allows the masked attention process to attend to actions that are before a predicted action and masks actions that are at or after the predicted action. Further, the sparsified causal self-attention mask 226 can mask out action encodings of prior actions that resulted in a state change of the object.

The prior actions that resulted in a state change of the object include prior actions that modified a geometry of the object. For example, the “Extrude” action a4 modifies the geometry of the object and the “Extrude” action a6 modifies the geometry of the object. The sparsified causal self-attention mask 226 can prevent the masked attention process from attending to the encodings of the prior actions that resulted in a modified geometry of the object. Thus, a predicted action token can only attend to action tokens after the latest state.

For example, when predicting the action a4, the sparsified causal self-attention mask 226 allows the masked attention process to attend to a0 through a3 (e.g., setting the element of the mask to 1) that is before a4 and masks out (e.g., setting the element of the mask to 0) a4 to a7 that are at or after the action a4. When predicting the action a5, the sparsified causal self-attention mask 226 allows the masked attention process to attend to none of the actions because the action a4 resulted in a state change. This means that the decoder can generate the predicted action a5 only based on state encodings of the state s4, as discussed herein in connection with the sparsified causal cross-attention mask 228 in FIG. 3E. When predicting the action a6, the sparsified causal self-attention mask 226 allows the masked attention process to attend a5 because the action a5 is before a6 and is after the state change from a4.

FIG. 3E shows an example of a sparsified causal cross-attention mask 228 for the sequence of actions 304 and the sequence of states 302 in FIG. 3A. The columns represent the input states: s0, s4, and s6. The state s0 is a null state indicating that the model does not have a valid 3D geometric representation yet. The rows represent the output actions: a1, a2, . . . , a8. The sparsified causal cross-attention mask 228 allows the masked attention process to attend a state encoding of a state for the object and prevents the masked attention process from attending to one or more previous state encodings of one or more previous states for the object that are before the state for the object.

For example, when predicting the action a5, the sparsified causal cross-attention mask 228 allows the masked attention process to attend to the state s4 (e.g., setting the element of the mask to 1) that is before a5 and masks out (e.g., setting the element of the mask to 0) state s0 that is before the action a4 and the state s6 that is after the action a4.

In some implementations, the decoder 214 can use both the sparsified causal self-attention mask 226 and the sparsified causal cross-attention mask 228. For example, when predicting the action a5, the masked attention process attends to the state s4 and none of the actions. When predicting the action a6, the masked attention process attends to (i) the state s4 and (ii) the action a5 that is before the action a6 and is after the state s4. Because a state encoding of the object can sufficiently represent a 3D model, the system 100 can use the sparsified causal attention process that does not use prior actions that result in a state change of the object. Thus, the system 100 can reduce computation cost without impacting the performance of the action sequence prediction.

Referring back to FIG. 2, the system 100 can provide the predicted action encoding 216 to an action decoder 218. The action decoder 218 decodes the predicted action encoding 216 to generate a predicted action 220. The action decoder 218 can include a feed-forward layer, such as a fully connected feed-forward layer. The predicted action 220 can include predicted action type and predicted action arguments. In some implementations, the action decoder 218 can include a first feed-forward layer that outputs probability distribution of the action type of the predicted action over a predetermined number of types of actions. In some implementations, the action decoder 218 can include a second feed-forward layer that outputs a probability distribution of the value for an argument of the predicted action over a predetermined range of argument values.

The system 100 can autoregressively predict a sequence of subsequent modification actions. After generating the predicted action 220 at a time point, the system 100 can feed the predicted action 220 as input action data 202 for generating the next predicted action at the next time point. If the predicted action 220 results in a state change of the object, the system 100 can generate a state of the object based on the predicted action 220. The system 100 can provide the state as part of the input state data 204 to generate the next predicted action at the next time point.

In some implementations, the system 100 can include an action positional encoding 246 in the action encoding 210. The action positional encoding 246 includes information about the relative or absolute position of the actions in the sequence of actions. FIG. 3F shows an example of an action positional encoding. In some implementations, when the system 100 uses a sparsified causal self-attention mask for the actions (e.g., mask 226 in FIG. 3D), the system 100 can use a sparsified action positional encoding. If an action results in a state change, the system can reset the action positional encodings 246 of the subsequence actions, e.g., reset to zero. Thus, the action positional encoding 246 of an action can be relative to the last state. FIG. 3G shows an example of a sparsified action positional encoding. The positional encoding of the action a5 has been reset to zero because a4 resulted in a state change and generated the state s4. Similarly, the positional encoding of the action a7 has been reset to zero because a6 resulted in a state change and generated the state s6.

In some implementations, the system 100 can include a state positional encoding 248 in the state encoding 212. The state positional encoding includes information about the relative or absolute position of the states in the sequence of states. In some implementations, when the system 100 uses a sparsified causal cross-attention mask for the states (e.g., the mask 224 in FIG. 3E), the masked attention process 200 can only attend to one state at a time. Therefore, the positional encoding can be less valuable. In some implementations, when the system 100 uses a sparsified causal cross-attention mask for the states, the system 100 can disable the state positional encoding such that the action sequence generation can be solely based on the model geometry represented in the state encodings.

The system 100 can display a final sequence of predicted modification actions 220 for the object in a user interface of a computer modeling program. For example, the system 100 can display the final sequence of predicted modification actions 220 on the UI 122 on the display device 120 of the computer 110.

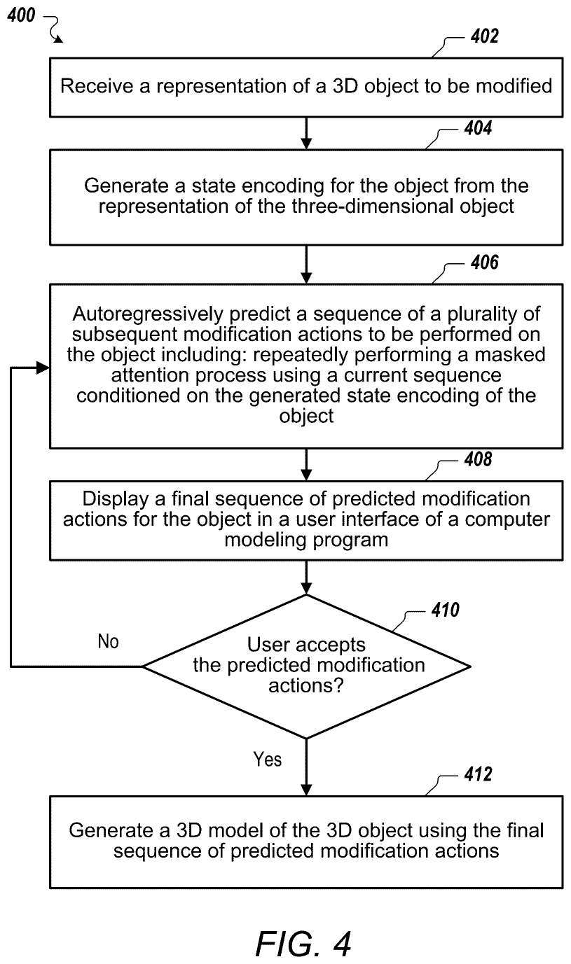

FIG. 4 is a flowchart showing an example of a process 400 to generate a 3D action sequence using a machine learning algorithm. For convenience, the process 400 will be described as being performed by a system of one or more computers located in one or more locations. For example, a CAD system, e.g., the system 100 depicted in FIG. 1, appropriately programmed in accordance with this specification, can perform the process 400.

The system receives a representation of a three-dimensional object to be modified (402). The system generates a state encoding for the object from the representation of the three-dimensional object (404).

The system autoregressively predicts a sequence of a plurality of subsequent modification actions to be performed on the object (406). In some implementations, the system can repeatedly perform a masked attention process using a current sequence conditioned on the generated state encoding of the object. The masked attention process can use: (i) a causal self-attention mask that allows the masked attention process to attend to encodings of prior actions, and (ii) a causal cross-attention mask that allows the masked attention process to attend to one or more state encodings of the object.

In some implementations, the causal self-attention mask can be a sparsified causal self-attention mask that masks out encodings of prior actions that resulted in a state change of the object. In some implementations, the prior actions that resulted in a state change of the object can include prior actions that modified a geometry of the object. In some implementations, the sparsified causal self-attention mask can prevent the masked attention process from attending to the encodings of the prior actions that resulted in a modified geometry of the object.

In some implementations, the causal cross-attention mask can be a sparsified causal cross-attention mask that allows the masked attention process to attend to a state encoding of a current state for the object and prevents the masked attention process from attending to one or more previous state encodings of one or more previous states for the object that are before the current state for the object.

Rather than using the full construction history of a CAD model, the system can autoregressively generate CAD actions solely from a state of the object using the sparsified causal self-attention mask and the sparsified causal cross-attention mask. The CAD system can more efficiently predict action sequences, and the CAD system can reduce computation resources, e.g., memory and processor operations of a graphics processing unit (GPU), required to predict the action sequences. Thus, the CAD system can be deployed on a wide range of devices.

The system displays a final sequence of predicted modification actions for the object in a user interface of a computer modeling program (408). In some implementations, the final sequence of predicted modification actions for the object can include actions that do not have a corresponding state encoding. For example, the actions in the final sequence of predicted modification actions may not result in a state change of the object, and thus the actions do not have a corresponding state encoding. In some implementations, the final sequence of predicted modification actions for the object can include an action that has a corresponding state encoding. For example, an action in the final sequence of predicted modification actions can result in a state change of the object, and thus the action can have a corresponding state encoding.

In some implementations, the system can receive a user input indicating whether a user accepts one or more actions included in the predicted modification actions (410). If the user input indicates that the user accepts the predicted modification actions, the system can generate a 3D model of the 3D object using the final sequence of predicted modification actions (412). If the user input indicates that the user does not accept one or more actions included in the predicted modification actions, the system can regenerate an updated sequence of predicted modification actions. In some implementations, if the user input indicates that the user does not accept a predicted action included in the predicted modification actions, the system can receive modification data provided by the user that can modify the predicted action.

In some implementations, the system can train a machine learning model to perform the masked attention process. FIG. 5 is a flowchart showing an example of a process 500 to train a machine learning model that can be used to generate a 3D action sequence. In some implementations, the machine learning model can include a transformer model. For convenience, the process 500 will be described as being performed by a system of one or more computers located in one or more locations. For example, a machine learning training system appropriately programmed in accordance with this specification, can perform the process 500. In some implementations, the system 100 as described in FIG. 1, appropriately programmed in accordance with this specification, can perform the process 500.

The system can obtain a collection of sequences of modification actions (502). Each sequence of modification actions can be used to construct a 3D model of a 3D object.

The system can generate a respective training example from each sequence of modification actions (504).

In some implementations, the system can generate, for the sequence of modification actions, one or more state encodings for an object generated at one or more locations in the sequence (506). In some implementations, the system can generate the training example as the one or more state encodings and one or more subsequent modification actions in the sequence (508). For example, a training example can include one or more state encodings and one or more subsequent modification actions in the sequence.

The system can train the machine learning model, e.g., a transformer model, using the generated training examples (512). In some implementations, the system can train the machine learning model using batches of training examples. Each batch is a group of training examples that are processed together as a single unit during one iteration of model training. Batch training allows for more efficient computation by updating the model parameters of the machine learning model based on combined information from that batch of data instead of processing each training example individually. Processing data in batches allows for faster training by leveraging parallel processing on GPUs. The system can calculate gradients of a loss function of the machine learning model based on the entire batch, and the gradients can be used to update the parameters of the model.

For example, referring to FIG. 2, the system 100 can generate a 2D tensor by concatenating action types for actions in a batch of action data 202. The dimensions of the 2D tensor can be the maximum action length times the batch size. The system can generate a 3D tensor by concatenating action arguments for actions in a batch of action data 202. The dimensions of the 3D tensor can be the number of arguments times the maximum action length times the batch size. The system can provide the 2D tensor and the 3D tensor as input to the action encoder 206 to generate the action encoding 210.

Similarly, the system 100 can obtain the state data 204 for the training examples in the batch. The system can generate a vector of states by flattening the states across all the sequences in the batch. The system can generate a first 2D tensor that can be later used to unflatten the vector of states. The system can generate a second 2D tensor that can store information on which time step each state corresponds to within the sequence of actions in each sequence, and the information can be used to calculate the cross-attention mask 224 or 228.

The state encoder 208 can include a neural network, e.g., a UV-net, that encodes the flattened vector of states to generate an encoding of the vector of states. The state encoder 208 can include a reshape layer that reshape the encoding of the vector of states according to the first 2D tensor to unflatten the encoding of the vector of states. After the unflattening, the state encoder 208 can generate state encoding 212 for the states in the batch.

In some implementations, the system can train the state encoder 208 (e.g., a UV-net) and the decoder 214 (e.g., a transformer) end-to-end. In some implementations, the system can use a pre-trained state encoder 208 (e.g., a pre-trained UV-net) and can only train the decoder 214 (e.g., a transformer).

The decoder 214 processes the action encoding 210 for the batch of training examples and the state encoding 212 for the batch of training examples. In some implementations, after the training is done, the system that uses a sparsified mask attention process can predict the next action token given a context of the last state and any actions after the last state. In some implementations, the system that uses a non-sparsified mask attention process can predict the next action token given a context of all previous actions and all previous states.

Referring back to FIG. 5, in some implementations, the system can generate a causal self-attention mask and a causal cross-attention mask for each training example in the batch (510). In some implementations, the system can use a different respective causal self-attention mask and a different respective causal cross-attention mask for each training example to train the transformer model.

In some implementations, the system can use a causal cross-attention mask during the training of the transformer model. For each training example, the causal cross-attention mask can allow the masked attention process to attend to one or more state encodings that are before and up to the state for the object and can mask out one or more state encodings that are after the state for the object.

In some implementations, the system can use a causal self-attention mask during the training of the transformer model. For each training example, the causal self-attention mask can allow the masked attention process to attend to one or more action encodings that are before the action for the object and can mask out one or more action encodings that are at or after the action for the object.

In some implementations, the system can use a sparsified causal cross-attention mask during the training of the transformer model. For each training example, the causal cross-attention mask can be a sparsified causal cross-attention mask. The sparsified causal cross-attention mask can allow the masked attention process to attend to the state encoding of the state for the object and can mask out one or more state encodings that are both before and after the state for the object.

In some implementations, the system can use a sparsified causal self-attention mask during the training of the transformer model. For each training example, the causal self-attention mask can be a sparsified causal self-attention mask. The sparsified causal self-attention mask can allow the masked attention process to attend to the action encoding of any action that is after the state for the object and can mask out encodings of prior actions that are resulted in or before the state for the object.

When training the machine learning model using a batch of training examples, the system can generate predicted actions for the batch of training examples using current parameters of the machine learning model. The predicted actions can include predicted action types and predicted action arguments of the predicted actions for the batch of training examples.

For example, for each training example in the batch and for each time step in the sequence of actions, the action decoder 218 can generate a probability distribution of the action type. Each predicted action can have zero, one, or more arguments. For each training example in the batch and for each time step in the sequence of actions and for each argument of a predicted action, the action decoder 218 can generate a probability distribution of the value for the argument. Thus, the system can simultaneously predict the action type and action arguments for the next CAD action.

The system can compute a value of a loss function by comparing the predicted actions and the ground truth action for the sequence of actions in the training examples. The loss function can include a combination of a loss for the predicted action and a loss for the predicted action arguments. For example, the loss function can be the following:

$$Loss = α \cdot CrossEntropy ( {y}_{args} , {\hat{y}}_{args} ) + β \cdot CrossEntropy ( {y}_{types} , {\hat{y}}_{types} ) .$$

Here, the y_{types} are the predicted action types for the predicted actions, and y_{args} are the predicted arguments for the predicted actions. The ŷ_{types} are the ground truth action types, and ŷ_{types} are the ground truth arguments. The CrossEntropy( ) function calculates the cross-entropy loss. The α and β are weights for the cross-entropy loss of the predicted action arguments and the cross-entropy loss of the predicted action types, respectively. The system can generate updated model parameter values by using an appropriate updating technique, e.g., stochastic gradient descent with backpropagation, based on the value of the loss function.

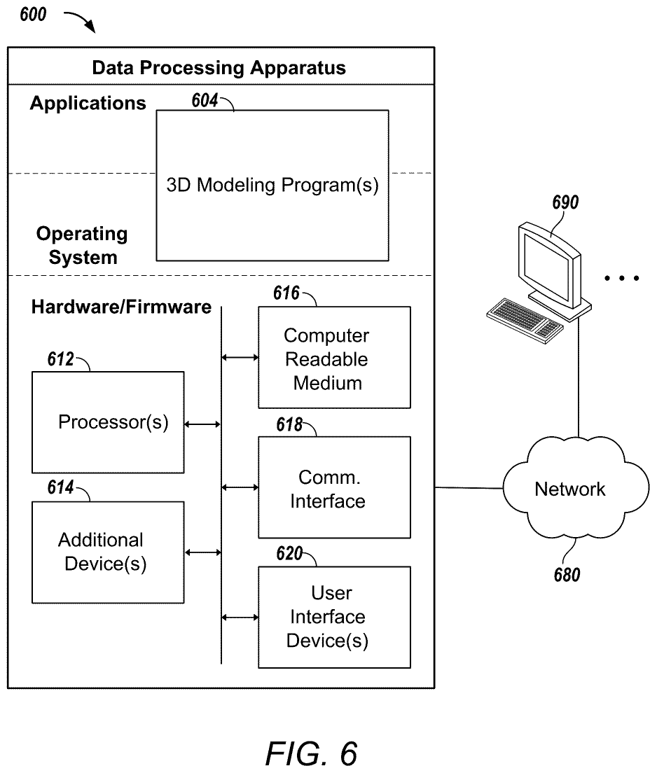

FIG. 6 is a schematic diagram of a data processing system including a data processing apparatus 600, which can be programmed as a client or as a server. The data processing apparatus 600 is connected with one or more computers 690 through a network 680. While only one computer is shown in FIG. 6 as the data processing apparatus 600, multiple computers can be used. The data processing apparatus 600 includes various software modules, which can be distributed between an application layer and an operating system. These can include executable and/or interpretable software programs or libraries, including tools and services of one or more 3D modeling program(s) 604 that implement the systems and techniques described herein. Thus, the 3D modeling program(s) 604 can be CAD program(s) that implements generating CAD action sequences by machine learning algorithm(s). Further, the program(s) 604 can potentially implement manufacturing control operations (e.g., generating and/or applying toolpath specifications to effect manufacturing of designed objects). In some cases, the program(s) 604 can potentially implement building construction management or video and movie production. The number of software modules used can vary from one implementation to another. Moreover, the software modules can be distributed on one or more data processing apparatus connected by one or more computer networks or other suitable communication networks.

The data processing apparatus 600 also includes hardware or firmware devices including one or more processors 612, one or more additional devices 614, a computer readable medium 616, a communication interface 618, and one or more user interface devices 620. Each processor 612 is capable of processing instructions for execution within the data processing apparatus 600. In some implementations, the processor 612 is a single or multi-threaded processor. Each processor 612 is capable of processing instructions stored on the computer readable medium 616 or on a storage device such as one of the additional devices 614. The data processing apparatus 600 uses the communication interface 618 to communicate with one or more computers 690, for example, over the network 680. Examples of user interface devices 620 include a display, a camera, a speaker, a microphone, a tactile feedback device, a keyboard, a mouse, and VR and/or AR equipment. The data processing apparatus 600 can store instructions that implement operations associated with the program(s) described above, for example, on the computer readable medium 616 or one or more additional devices 614, for example, one or more of a hard disk device, an optical disk device, a tape device, and a solid state memory device.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented using one or more modules of computer program instructions encoded on a non-transitory computer-readable medium for execution by, or to control the operation of, data processing apparatus. The computer-readable medium can be a manufactured product, such as a hard drive in a computer system or an optical disc sold through retail channels, or an embedded system. The computer-readable medium can be acquired separately and later encoded with the one or more modules of computer program instructions, such as by delivery of the one or more modules of computer program instructions over a wired or wireless network. The computer-readable medium can be a machine-readable storage device, a machine-readable storage substrate, a memory device, or a combination of one or more of them.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, a runtime environment, or a combination of one or more of them. In addition, the apparatus can employ various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM (Erasable Programmable Read-Only Memory), EEPROM (Electrically Erasable Programmable Read-Only Memory), and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., an LCD (liquid crystal display) display device, an OLED (organic light emitting diode) display device, or another monitor, for displaying information to the user, and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The computing system can include clients and servers. A client and server are generally remote from each other and typically interact through a communication network. The relationship of client and server arises by virtue of computer programs running on the respective computers and having a client-server relationship to each other. Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described is this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While this specification contains many implementation details, these should not be construed as limitations on the scope of what is being or may be claimed, but rather as descriptions of features specific to particular embodiments of the disclosed subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desired results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the invention have been described. Other embodiments are within the scope of the following claims.

What is claimed is:

1. A computer-implemented method comprising:
receiving a representation of a three-dimensional object to be modified;
generating a state encoding for the object from the representation of the three-dimensional object;
autoregressively predicting a sequence of a plurality of subsequent modification actions to be performed on the object including:
repeatedly performing a masked attention process using a current sequence conditioned on the generated state encoding of the object,
wherein the masked attention process uses: (i) a causal self-attention mask that allows the masked attention process to attend to encodings of prior actions, and (ii) a causal cross-attention mask that allows the masked attention process to attend to one or more state encodings of the object; and
displaying a final sequence of predicted modification actions for the object in a user interface of a computer modeling program.

2. The method of claim 1, wherein the causal self-attention mask is a sparsified causal self-attention mask that masks out encodings of prior actions that resulted in a state change of the object.

3. The method of claim 2, wherein the prior actions that resulted in a state change of the object include prior actions that modified a geometry of the object.

4. The method of claim 2, wherein the sparsified causal self-attention mask prevents the masked attention process from attending to the encodings of the prior actions that resulted in a modified geometry of the object.

5. The method of claim 1, wherein the causal cross-attention mask is a sparsified causal cross-attention mask that allows the masked attention process to attend to a state encoding of a current state for the object and prevents the masked attention process from attending to one or more previous state encodings of one or more previous states for the object that are before the current state for the object.

6. The method of claim 1, wherein the final sequence of predicted modification actions for the object includes actions that do not have a corresponding state encoding.

7. The method of claim 1, further comprising training a transformer model to perform the masked attention process.

8. The method of claim 7, wherein training the transformer model comprises:
obtaining a collection of sequences of modification actions;
generating a respective training example from each sequence of modification actions, including:
generating, for the sequence of modification actions, one or more state encodings for an object generated at one or more locations in the sequence, and
generating the training example as the one or more state encodings and one or more subsequent modification actions in the sequence; and
training the transformer model using the generated training examples.

9. The method of claim 8, wherein training the transformer model using the generated training examples comprises using a different respective causal self-attention mask and a different respective causal cross-attention mask for each training example.

10. The method of claim 9, wherein for each training example, the causal cross-attention mask allows the masked attention process to attend to one or more state encodings that are before and up to a current state for the object and masks out one or more state encodings that are after the current state for the object.

11. The method of claim 9, wherein for each training example, the causal cross-attention mask is a sparsified causal cross-attention mask, and the sparsified causal cross-attention mask allows the masked attention process to attend to the state encoding of a current state for the object and masks out one or more state encodings that are both before and after the current state for the object.

12. A system comprising:
a non-transitory storage medium having instructions of a computer modeling program stored thereon; and
one or more data processing apparatus configured to run the instructions of the computer modeling program to perform operations specified by the instructions of the computer modeling program;
wherein the operations comprise:
receiving a representation of a three-dimensional object to be modified;
generating a state encoding for the object from the representation of the three-dimensional object;
autoregressively predicting a sequence of a plurality of subsequent modification actions to be performed on the object including:
repeatedly performing a masked attention process using a current sequence conditioned on the generated state encoding of the object,
wherein the masked attention process uses: (i) a causal self-attention mask that allows the masked attention process to attend to encodings of prior actions, and (ii) a causal cross-attention mask that allows the masked attention process to attend to one or more state encodings of the object; and
displaying a final sequence of predicted modification actions for the object in a user interface of the computer modeling program.

13. The system of claim 12, wherein the causal self-attention mask is a sparsified causal self-attention mask that masks out encodings of prior actions that resulted in a state change of the object.

14. The system of claim 13, wherein the prior actions that resulted in a state change of the object include prior actions that modified a geometry of the object.

15. The system of claim 13, wherein the sparsified causal self-attention mask prevents the masked attention process from attending to the encodings of the prior actions that resulted in a modified geometry of the object.

16. The system of claim 12, wherein the causal cross-attention mask is a sparsified causal cross-attention mask that allows the masked attention process to attend to a state encoding of a current state for the object and prevents the masked attention process from attending to one or more previous state encodings of one or more previous states for the object that are before the current state for the object.

17. The system of claim 12, wherein the final sequence of predicted modification actions for the object includes actions that do not have a corresponding state encoding.

18. The system of claim 12, wherein the operations further comprise training a transformer model to perform the masked attention process.

19. The system of claim 18, wherein training the transformer model comprises:
obtaining a collection of sequences of modification actions;
generating a respective training example from each sequence of modification actions, including:
generating, for the sequence of modification actions, one or more state encodings for an object generated at one or more locations in the sequence, and
generating the training example as the one or more state encodings and one or more subsequent modification actions in the sequence; and
training the transformer model using the generated training examples.

20. A non-transitory computer-readable medium encoding instructions operable to cause data processing apparatus to perform operations comprising:
receiving a representation of a three-dimensional object to be modified;
generating a state encoding for the object from the representation of the three-dimensional object;
autoregressively predicting a sequence of a plurality of subsequent modification actions to be performed on the object including:
repeatedly performing a masked attention process using a current sequence conditioned on the generated state encoding of the object,
wherein the masked attention process uses: (i) a causal self-attention mask that allows the masked attention process to attend to encodings of prior actions, and (ii) a causal cross-attention mask that allows the masked attention process to attend to one or more state encodings of the object; and
displaying a final sequence of predicted modification actions for the object in a user interface of a computer modeling program.
